(19) United States
(12) Patent Application Publication
(10) Pub. No.: US 2022/0343651 A1
(43) Pub. Date: Oct. 27, 2022

(54) METHOD AND DEVICE FOR GENERATING SPEECH IMAGE

(71) Applicant: DEEPBRAIN AI INC., Seoul (KR)

(72) Inventors: Gyeongsu CHAE, Seoul (KR); Guembuel HWANG, Seoul (KR)

(21) Appl. No.: 17/762,876

(22) PCT Filed: Dec. 8, 2020
(86) PCT No.: PCT/KR2020/017848

§ 371 Date: Mar. 23, 2022

(30) Foreign Application Priority Data
Jul. 27, 2020 (KR) 10-2020-0093374

(51) Int. Cl. G06V 20/40; G10L 21/055; G06N 3/04

(52) U.S. Cl. CPC G06V 20/46; G10L 21/055; G06N 3/0454

(57) ABSTRACT

A device for generating a speech image according to an embodiment disclosed herein is a speech image generation device including one or more processors and a memory storing one or more programs executed by the one or more processors. The device includes a first machine learning model that extracts an image feature with a speech image of a person as an input to reconstruct the speech image from the extracted image feature and a second machine learning model that predicts the image feature with a speech audio signal of the person as an input.

### CROSS REFERENCE TO RELATED APPLICATIONS AND CLAIM OF PRIORITY

This application claims benefit under 35 U.S.C. 119, 120, 121, or 365(c), and is a National Stage entry from International Application No. PCT/KR2020/017848, filed Dec. 8, 2020, which claims priority to the benefit of Korean Patent Application No. 10-2020-0093374 filed on Jul. 27, 2020 the entirety the entire contents of which are incorporated herein by reference.

### BACKGROUND

### 1. Technical Field

Embodiments of the present disclosure relate to a technology for generating a speech image, and more particularly, a technology for generating a speech image with a speech audio signal as a single input.

### 2. Background Art

With recent technological development in the artificial intelligence field, various types of contents are being generated based on artificial intelligence technology. For example, there is a case in which, when there is a voice message to be transmitted, a speech moving image is generated as if a famous person (for example, a president) speaks the voice message in order to draw people's attention. This is achieved by generating mouth shapes or the like to fit a specific message, just like a famous person speaking the specific message in an image of the famous person.

Meanwhile, the most direct and simplest form of a neural network structure that converts voice information into image information is to extract a feature Z from voice information X input through an encoder 50 and output image information Y from the extracted feature Z by a decoder 60, as shown in FIG. 1.

However, in such a neural network structure, it is difficult to induce or constrain the shapes of the face and body to be maintained due to the characteristics of image information using units of pixels. Therefore, there is a need for a way of, while converting one category (domain) of information (e.g., voice information) into another category of information (e.g., image information), maintaining the characteristics of data for the corresponding category.

Further, the shape or movement of the speech part (for example, the shape or movement of the mouth) in an image may be generated based on information in a relatively short time unit corresponding to a syllable or part of a word; however, in order to generate motions related to the contents and situation of speech, such as head and body movements or facial expression changes during speech, there is a need for a neural network model structure capable of processing information in a relatively long time unit, such as multiple words and multiple sentence units.

### SUMMARY

The disclosed embodiments are to provide a technique capable of generating a speech image by using a speech audio signal as a single input.

A device for generating a speech image according to an embodiment disclosed herein is a speech image generation device including one or more processors and a memory storing one or more programs executed by the one or more processors, and the device includes: a first machine learning model that extracts an image feature with a speech image of a person as an input to reconstruct the speech image from the extracted image feature; and a second machine learning model that predicts the image feature with a speech audio signal of the person as an input.

The speech audio signal may be an audio part of the speech image, and the speech image input to the first machine learning model and the speech audio signal input to the second machine learning model may be synchronized in time.

The first machine learning model may include an image feature extraction unit that extracts the image feature with the speech image as an input, and an image reconstruction unit that reconstructs the speech image with the image feature output from the image feature extraction unit as an input.

The first machine learning model may be trained such that the reconstructed speech image output from the image reconstruction unit is close to the speech image input to the image feature extraction unit.

The image feature extraction unit may receive the speech image in units of image frames, and extract an image feature for each of the image frames to output an image feature sequence, and the image reconstruction unit may output the speech image reconstructed for each of the image frames with the image feature for each of the image frames as an input.

The second machine learning model may include a voice feature extraction unit that extracts a voice feature with the speech audio signal as an input, and an image feature prediction unit that predicts the image feature output from the image feature extraction unit with the voice feature output from the voice feature extraction unit as an input.

The voice feature extraction unit may extract a voice feature from the speech audio signal for a section corresponding to each of the image frames to output a voice feature sequence, and the image feature prediction unit may predict the image feature sequence with the voice feature sequence as an input.

The image feature prediction unit may predict an image feature of an n-th image frame in the speech image based on a voice feature extracted from a section of a speech audio signal corresponding to the n-th image frame.

A loss function (L_{seq}) of the second machine learning model may be expressed by Equation below.

L_{seq}=∥Z−\hat{Z}∥ (Equation)

Z: Image feature sequence generated by the image feature extraction unit of the first machine learning model, Z={E_{img}(y₀; θ_{enc}), E_{img}(y₁; θ_{enc}), . . . E_{img}(yₙ; θ_{enc})}

E_{img}: Neural network constituting the image feature extraction unit

θ_{enc}: Parameter of the neural network E_{img}

yₙ: n-th image frame of the speech image Y

\hat{Z}: Image feature sequence output from the image feature prediction unit of the second machine learning model, \hat{Z}=P(E_{aud}(X; φ_{enc}); ϕₚ)

E_{aud}: Neural network constituting the voice feature extraction unit

ϕ_{enc}: Parameter of the neural network E_{aud}

P: Neural network constituting the image feature prediction unit

ϕₚ: Parameter of the neural network P

X: Speech audio signal, X={x₀, x₁, x₂, . . . , xₙ}

xₙ: Speech audio signal corresponding to the n-th image frame

∥Z−\hat{Z}∥: Function for finding the difference between Z and \hat{Z}

An optimized parameter (φ*_{enc}, φ*ₚ) of the second machine learning model may be calculated by Equation below.

φ*_{enc}, φ*ₚ=arg min_{φenc, φp} L_{seq} (Equation)

arg min_{99 enc, ϕp}L_{seq}: A function for finding ϕ_{enc}, ϕₚ, which minimizes L_{seq} (the loss function of the second machine learning model)

A method for generating a speech image is a method executed by a computing device including one or more processors and a memory storing one or more programs executed by the one or more processors, and the method includes: extracting, in a first machine learning model, an image feature with a speech image of a person as an input to reconstruct the speech image from the extracted image feature; and predicting, in a second machine learning model, the image feature with a speech audio signal of the person as an input.

According to disclosed embodiments, through the first machine learning model, an image feature is extracted from a speech image and the speech image is reconstructed from the extracted image feature, and through the second machine learning model, a voice feature is extracted from a speech audio signal and an image feature corresponding to the voice feature is predicted from the extracted voice feature, and thus, when the speech image is reconstructed through the predicted image feature, the shapes of the face and body included in the image may be well maintained.

That is, when an image feature is predicted from a voice feature in the second machine learning model, learning is performed about a distribution in a compressed form, not image data itself consisting of pixel values, and thus, when the value generated from the learned distribution (that is, predicted image feature) is reconstructed into the image again, the shapes of the face and body included in the image may be well maintained.

In the disclosed embodiments, a speech image of a specific person may be generated with only the speech voice signal as an input (that is, with a speech voice signal as a single input). In this case, in addition to speech parts directly related to voice (e.g., mouth, chin, neck, and the like), specific motions (for example, nodding of the head to emphasize words) that appear when a specific person is speaking and blinking of eyes that appear naturally may be generated only with the speech voice signal.

### BRIEF DESCRIPTION OF THE DRAWINGS

FIG. 1 is a diagram showing a general neural network structure that converts voice information into image information.

FIG. 2 is a diagram schematically showing a configuration of a device for generating a speech image according to an embodiment of the present disclosure.

FIG. 3 is a diagram showing a configuration of a first machine learning model according to an embodiment of the present disclosure.

FIG. 4 is a diagram showing a configuration of a second machine learning model according to an embodiment of the present disclosure.

FIG. 5 is a diagram illustrating a state in which a speech image is generated only with a speech audio signal according to an embodiment of the present disclosure.

FIG. 6 is a block diagram exemplarily illustrating a computing environment that includes a computing device suitable for use in exemplary embodiments.

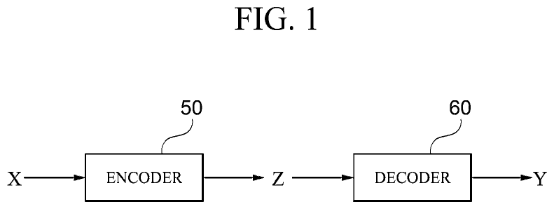

### DETAILED DESCRIPTION

Hereinafter, specific embodiments of the present disclosure will be described with reference to the accompanying drawings. The following detailed description is provided to assist in a comprehensive understanding of the methods, devices and/or systems described herein. However, the detailed description is only for illustrative purposes and the present disclosure is not limited thereto.

In describing the embodiments of the present disclosure, when it is determined that detailed descriptions of known technology related to the present disclosure may unnecessarily obscure the gist of the present disclosure, the detailed descriptions thereof will be omitted. The terms used below are defined in consideration of functions in the present disclosure, but may be changed depending on the customary practice or the intention of a user or operator. Thus, the definitions should be determined based on the overall content of the present specification. The terms used herein are only for describing the embodiments of the present disclosure, and should not be construed as limitative. Unless expressly used otherwise, a singular form includes a plural form. In the present description, the terms “including”, “comprising”, “having”, and the like are used to indicate certain characteristics, numbers, steps, operations, elements, and a portion or combination thereof, but should not be interpreted to preclude one or more other characteristics, numbers, steps, operations, elements, and a portion or combination thereof.

In the following description, the terminology “transmission”, “communication”, “reception” of a signal or information and terminology similar thereto may include a meaning in which the signal or information is directly transmitted from one element to another element and transmitted from one element to another element through an intervening element. In particular, “transmission” or “sending” of the signal or information to one element may indicate a final destination of the signal or information and may not imply a direct destination. The same is true for “reception” of the signal or information. In addition, in the present specification, a meaning in which two or more pieces of data or information are “related” indicates that when any one piece of data (or information) is obtained, at least a portion of other data (or information) may be obtained based thereon.

Further, it will be understood that, although the terms first, second, etc. may be used herein to describe various elements, these elements should not be limited by these terms. These terms may be used to distinguish one element from another element. For example, without departing from the scope of the present disclosure, a first element could be termed a second element, and similarly, a second element could be termed a first element.

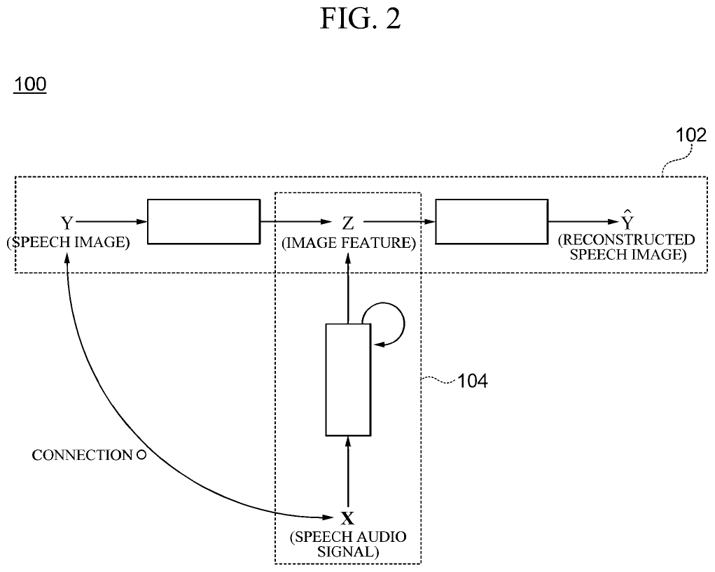

FIG. 2 is a diagram schematically showing a configuration of a device for generating a speech image according to an embodiment of the present disclosure.

Referring to FIG. 2, a device for generating a speech image (speech image generation device) 100 may include a first machine learning model 102 and a second machine learning model 104. The speech image generation device 100 may be built based on a machine learning technology.

The first machine learning model 102 and the second machine learning model 104 may be simultaneously trained, but are not limited thereto and may be sequentially trained. That is, the first machine learning model 102 may be trained, and then the second machine learning model 104 may be trained. Hereinafter, a learning process for generating a speech image will be mainly described.

The first machine learning model 102 may be trained to extract an image feature Z with a speech image Y of a person as an input, and reconstruct a speech image from the extracted image feature Z (that is, generate a reconstructed speech image Ŷ).

In an exemplary embodiment, the first machine learning model 102 may receive the speech image Y in units of image frames, and extract the image feature Z for each image frame. The first machine learning model 102 may generate the reconstructed speech image Ŷ for each image frame with the image feature Z for each image frame as an input.

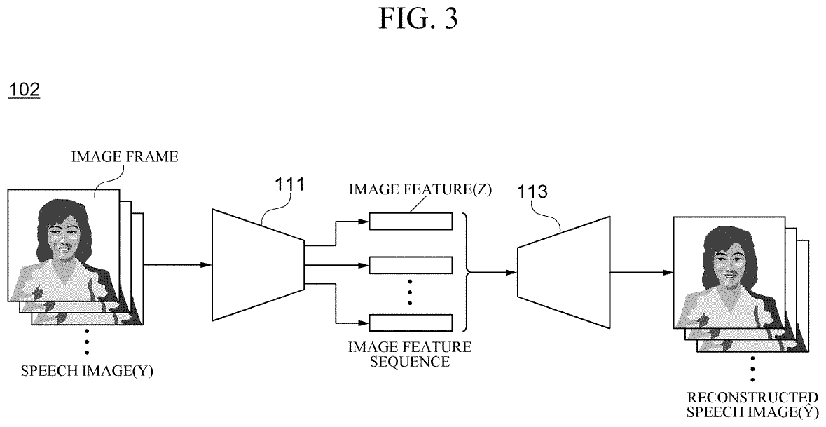

FIG. 3 is a diagram showing a configuration of the first machine learning model 102 according to an embodiment of the present disclosure. Referring to FIG. 3, the first machine learning model 102 may include an image feature extraction unit 111 and an image reconstruction unit 113.

The image feature extraction unit 111 may be trained to extract the image feature Z with the speech image Y of a person as an input. The image feature Z may be in the form of a vector or a form of a tensor.

Here, the speech image Y may be a video part of an image in which the person is speaking. In an exemplary embodiment, the speech image Y may be an image including not only the face but also the upper body so that movements of the neck, shoulders, or the like, appearing when the person is speaking are shown. However, the speech image Y is not limited thereto, and may include a face image of the person or a full body image of the person.

In an exemplary embodiment, the image feature extraction unit 111 may include one or more convolutional layers and one or more pooling layers. The convolution layer may extract feature values of pixels corresponding to a filter having a preset size (e.g., pixel size of 3×3) while moving the filter from the input speech image at regular intervals. The pooling layer may perform down sampling by receiving the output of the convolution layer as an input.

The image feature Z extracted by the image feature extraction unit 111 may have the form of a vector or tensor that partially or completely loses its spatial form. In addition, the image feature Z may be compressed at an appropriate level to effectively predict the image feature based on the speech voice signal by the second machine learning model 104 while including main information about the speech image Y.

The image feature extraction unit 111 may receive the speech image Y in units of image frames, and extract the image feature Z for each image frame. In this case, the speech image Y of a preset unit time (e.g., one second, two seconds, or the like) may be input to the image feature extraction unit 111.

Here, the image frames of the speech image Y are sequential with respect to time, and thus the image features Z output from the image feature extraction unit 111 are also sequential with respect to time. Hereinafter, a set of image features Z sequential with respect to time may be referred to as an image feature sequence. That is, when a plurality of image frames for the speech image Y are input to the image feature extraction unit 111, the image feature extraction unit 111 extracts the image feature Z for each image frame to generate an image feature sequence.

The image reconstruction unit 113 may be trained to reconstruct the speech image Y with the image feature Z output from the image feature extraction unit 111 as an input. That is, the image reconstruction unit 113 may be trained to output the reconstructed speech image Ŷ with the image feature Z as an input. In an exemplary embodiment, the image reconstruction unit 113 may output a reconstructed speech image by performing deconvolution and then up-sampling on the image feature.

The image reconstruction unit 113 may be trained to output a speech image Ŷ reconstructed for each image frame with the image feature Z for each image frame as an input.

The first machine learning model 102 may compare the reconstructed speech image Ŷ output from the image reconstruction unit 113 with the original speech image Y (that is, the speech image input to the image feature extraction unit 111), and adjust learning parameters (e.g., loss function, softmax function, or the like) so that the reconstructed speech image Ŷ is close to the original speech image Y.

A loss function L_{reconstruction} of the first machine learning model 102 may be expressed by Equation 1 below.

L_{reconstruction}=∥Y−D(E_{img}(Y;θ_{enc}); θ_{dec})∥ (Equation 1)

Here, Y denotes a speech image input to the image feature extraction unit 111, D denotes a neural network constituting the image reconstruction unit 113, E_{img} denotes a neural network constituting the image feature extraction unit 111, and θ_{enc} denotes a parameter of the neural network E_{img}, and θ_{dec} denotes a parameter of the neural network D. Further, a function ∥A−B∥ denotes a function for finding the difference between A and B (e.g., a function for finding the Euclidean distance (L2 distance) or Manhattan distance (L1 distance) between A and B, or the like).

In addition, optimized parameters θ*_{enc}, θ*_{dec} of the first machine learning model 102 may be expressed by Equation 2 below.

θ*_{enc}, θ*_{dec}=arg min_{θenc, θdec} L_{reconstruction} (Equation 2)

Here, arg min_{θenc, θdec} L_{reconstruction} denotes a function for finding θ_{enc}, θ_{dec}, which minimizes L_{reconstruction} (that is, the loss function of the first machine learning model 102).

Meanwhile, here, the first machine learning model 102 has been described as including the image feature extraction unit 111 and the image reconstruction unit 113; however, the neural network structure constituting the first machine learning model 102 is not limited thereto, and may be implemented using various neural network structures other than that.

That is, the first machine learning model 102 may be implemented with various neural structures (for example, a residual network (ResNet), adaptive instance normalization (AdaIN), or the like) capable of compressing the speech image and extracting the image feature (feature extraction unit), and reconstructing a speech image based on the extracted feature (image reconstruction unit).

In addition, the first machine learning model 102 may be implemented through a generative adversarial network (GAN) including a discriminator that makes the reconstructed speech image close to the original speech image. In addition, the first machine learning model 102 may be implemented through a variational autoencoder (VAE) including a KL-divergence loss that is capable of systematically separating and controlling the components of the image feature vector.

The second machine learning model 104 may be trained to output the image feature Z with the speech voice signal X of the person as an input. That is, the second machine learning model 104 may be trained to output the image feature Z extracted from the speech image Y by the first machine learning model 104 with the speech voice signal X as an input.

Here, the speech voice signal X may be an audio part of the speech image Y. That is, the speech image Y, which is the video part of the image in which the person is speaking, is input to the first machine learning model 102, and the speech audio signal X, which is the audio part of the image in which the person is speaking, may be input to the second machine learning model 104.

Times of the speech image Y input to the first machine learning model 102 and the speech audio signal X input to the second machine learning model 104 may be synchronized with each other. In addition, a time section of the speech image Y input to the first machine learning model 102 and a time section of the speech audio signal X input to the second machine learning model 104 may coincide with each other. When the speech image Y of a preset unit time is input to the first machine learning model 102, the speech audio signal X of the unit time may be input to the second machine learning model 104.

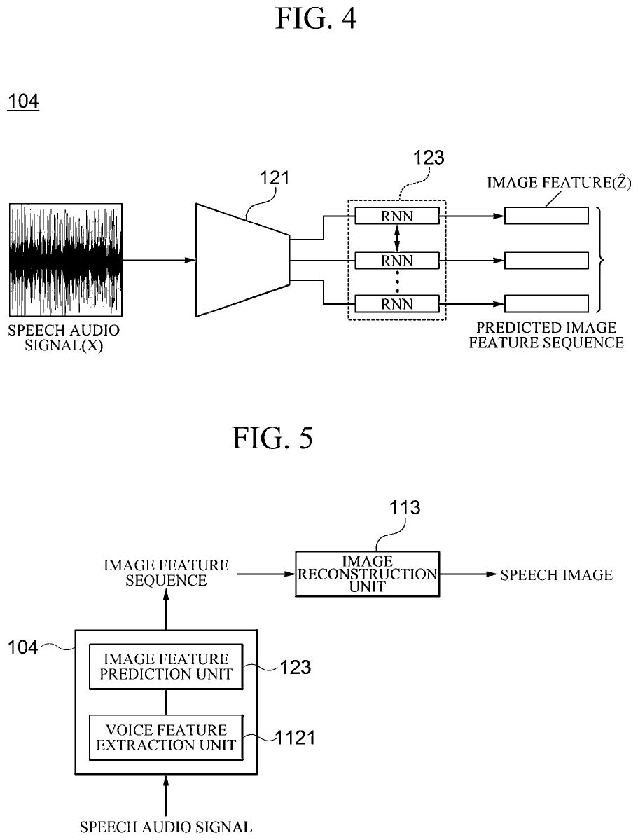

FIG. 4 is a diagram showing a configuration of the second machine learning model 104 according to an embodiment of the present disclosure. Referring to FIG. 4, the second machine learning model 104 may include a voice feature extraction unit 121 and an image feature prediction unit 123.

The voice feature extraction unit 121 may extract the voice feature with the speech audio signal X as an input. The image feature Z may be in the form of a vector or a form of a tensor. In an exemplary embodiment, the voice feature extraction unit 121 may extract a voice feature from the speech audio signal X corresponding to each image frame of the speech image Y.

Since the speech audio signal X is input with the same amount of units of time as the speech image Y and the image frames of the speech image Y are sequential with respect to time, the voice feature extraction unit 121 sequentially extracts voice features from the speech audio signal X for sections corresponding to respective image frames. Hereinafter, a set of voice features sequential with respect to time may be referred to as a voice feature sequence. That is, the voice feature extraction unit 121 may generate the voice feature sequence by extracting a voice feature for each section of the speech audio signal corresponding to each image frame.

In the exemplary embodiment, when the speech audio signal X={x₀, x₁, x₂, . . . , xₙ} (where xₙ is a speech audio signal corresponding to the n-th image frame), the voice feature extraction unit 121 may generate the voice feature sequence F={f₀, f₁, f₂, . . . , fₙ} (where fₙ is the voice feature of the speech audio signal corresponding to the n-th image frame) from the speech audio signal X.

For example, the voice feature extraction unit 121 may extract the voice feature from the speech audio signal through a plurality of convolutional layers. In addition, the voice feature extraction unit 121 may further include a dropout layer to improve generalization performance of the neural network and to solve an overfitting problem.

The image feature prediction unit 123 may be trained to predict the image feature with the voice feature extracted by the voice feature extraction unit 121 as an input. That is, the image feature prediction unit 123 may be trained to predict the image feature of the n-th image frame with the voice feature extracted from the speech audio signal corresponding to the n-th image frame as an input.

The image feature prediction unit 123 may be trained to, when the voice feature sequence is input from the voice feature extraction unit 121, predict, from the voice feature sequence F={f₀, f₁, f₂, . . . fₙ}, an image feature sequence Z={z₀, z₁, z₂, . . . , zₙ} (where zₙ is the image feature extracted from the n-th image frame) generated by the image feature extraction unit 111 of the first machine learning model 102.

In an exemplary embodiment, the image feature prediction unit 123 may be implemented through a structure of a recurrent neural network series. For example, the image feature prediction unit 123 may be implemented through a recurrent neural network (RNN) having a bidirectional structure that considers both the bidirectional features of the voice feature sequence. However, the image feature prediction unit 123 is not limited thereto and may be implemented through various neural network structures such as a long short-term memory (LSTM) and a gated recurrent unit (GRU).

The second machine learning model 104 may adjust a learning parameter such that the image feature sequence output from the image feature prediction unit 123 is close to the image feature sequence generated by the image feature extraction unit 111 of the first machine learning model 102. A loss function L_{seq} of the second machine learning model 104 may be expressed by Equation 3 below.

L_{seq}=∥Z−\hat{Z}∥ (Equation 3)

Here, Z is an image feature sequence generated by the image feature extraction unit 111 of the first machine learning model 102, and may be expressed as Z={E_{img}(y₀; θ_{enc}), E_{img} (y₁; θ_{enc})}. E_{img} denotes a neural network constituting the image feature extraction unit 111, θ_{enc} denotes a parameter of the neural network E_{img}, and yₙ denotes the n-th image frame of the speech image Y.

In addition, \hat{Z} is an image feature sequence output from the image feature prediction unit 123 of the second machine learning model 104, and may be expressed as \hat{Z}=P (E_{aud}(X; ϕ_{enc}); ϕₚ). E_{aud} denotes a neural network constituting the voice feature extraction unit 121, ϕ_{enc} denotes a parameter of the neural network E_{aud} P denotes a neural network constituting the image feature prediction unit 123, ϕₚ denotes a parameter of the neural network P, and X is a speech audio signal and may be expressed as X={x₀, x₁, x₂, . . . , xₙ}.

In addition, optimized parameters φ*_{enc}, φ*ₚ of the second machine learning model 104 may be expressed by Equation 4 below.

φ*_{enc}, φ*ₚ=arg min_{φenc, φp}L_{seq} (Equation 4)

Here, arg min_{ϕenc, ϕp}L_{seq} denotes a function for finding ϕ_{enc}, ϕₚ, which minimizes L_{seq} (that is, the loss function of the second machine learning model 104).

According to the disclosed embodiment, through the first machine learning model 102, an image feature is extracted from a speech image and the speech image is reconstructed from the extracted image feature, and through the second machine learning model 104, a voice feature is extracted from a speech audio signal and an image feature corresponding to the voice feature is predicted from the extracted voice feature, and thus, when the speech image is reconstructed through the predicted image feature, the shapes of the face and body included in the image may be well maintained.

That is, when an image feature is predicted from a voice feature in the second machine learning model 104, learning is performed about a distribution in a compressed form, not image data itself consisting of pixels, and thus, when the value generated from the learned distribution (that is, predicted image feature) is reconstructed into the image again, the shapes of the face and body included in the image may be well maintained.

FIG. 5 is a diagram illustrating a state in which a speech image is generated only with a speech audio signal according to an embodiment of the present disclosure. Here, a case will be described in which, in a state in which the first machine learning model 102 and the second machine learning model 104 are trained, a speech audio signal is input to the second machine learning model 104 to generate a speech image.

Referring to FIG. 5, the voice feature extraction unit 121 of the second machine learning model 104 receives a speech audio signal. The voice feature extraction unit 121 may extract each of voice features from the speech audio signal to generate a voice feature sequence. The voice feature extraction unit 121 may extract a voice feature for each preset section (e.g., a time section corresponding to one image frame) from the speech audio signal to generate the voice feature sequence.

The image feature prediction unit 123 of the second machine learning model 104 may predict the image feature sequence with the voice feature sequence output from the voice feature extraction unit 121 as an input.

The image reconstruction unit 113 of the first machine learning model 104 may generate a speech image with the image feature sequence output from the image feature prediction unit 123 as an input. The image reconstruction unit 113 may generate an image frame from each image feature included in the image feature sequence, and connect the generated image frames in chronological order to generate the speech image.

According to the disclosed embodiment, a speech image of a specific person may be generated with only the speech voice signal as an input (that is, with a speech voice signal as a single input). In this case, in addition to speech parts directly related to voice (e.g., mouth, chin, neck, and the like), specific motions (for example, nodding of the head to emphasize words) that appear when a specific person is speaking and blinking of eyes that appear naturally may be generated only with the speech voice signal.

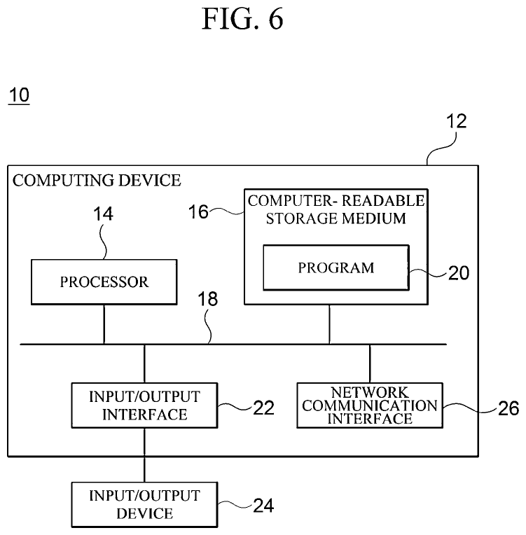

FIG. 6 is a block diagram exemplarily illustrating a computing environment 10 that includes a computing device suitable for use in exemplary embodiments. In the illustrated embodiment, each component may have different functions and capabilities in addition to those described below, and additional components may be included in addition to those described below.

The illustrated computing environment 10 includes a computing device 12. In an embodiment, the computing device 12 may be the speech image generation device 100.

The computing device 12 includes at least one processor 14, a computer-readable storage medium 16, and a communication bus 18. The processor 14 may cause the computing device 12 to operate according to the above-described exemplary embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the exemplary embodiments.

The computer-readable storage medium 16 is configured to store computer-executable instructions or program codes, program data, and/or other suitable forms of information. A program 20 stored in the computer-readable storage medium 16 includes a set of instructions executable by the processor 14. In an embodiment, the computer-readable storage medium 16 may be a memory (a volatile memory such as a random access memory, a non-volatile memory, or any suitable combination thereof), one or more magnetic disk storage devices, optical disc storage devices, flash memory devices, other types of storage media that are accessible by the computing device 12 and may store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The exemplary input/output device 24 may include a pointing device (a mouse, a trackpad, or the like), a keyboard, a touch input device (a touch pad, a touch screen, or the like), a voice or sound input device, input devices such as various types of sensor devices and/or imaging devices, and/or output devices such as a display device, a printer, an interlocutor, and/or a network card. The exemplary input/output device 24 may be included inside the computing device 12 as a component constituting the computing device 12, or may be connected to the computing device 12 as a separate device distinct from the computing device 12.

Although the representative embodiments of the present disclosure have been described in detail as above, those skilled in the art will understand that various modifications may be made thereto without departing from the scope of the present disclosure. Therefore, the scope of rights of the present disclosure should not be limited to the described embodiments, but should be defined not only by the claims set forth below but also by equivalents of the claims.

1. A device for generating a speech image, the device comprising:
one or more processors;
a memory storing one or more programs executed by the one or more processors;
a first machine learning model that is executed by the one or more processors and extracts an image feature with a speech image of a person as an input to reconstruct a speech image from the extracted image feature; and
a second machine learning model that is executed by the one or more processors and predicts the image feature with a speech audio signal of the person as an input.

2. The device of claim 1, wherein the speech audio signal is an audio part of the speech image; and
the speech image input to the first machine learning model and the speech audio signal input to the second machine learning model are synchronized in time.

3. The device of claim 2, wherein the first machine learning model includes:
an image feature extraction unit configured to extract the image feature with the speech image as an input; and
an image reconstruction unit configured to reconstruct the speech image with the image feature output from the image feature extraction unit as an input.

4. The device of claim 3, wherein the first machine learning model is trained such that the reconstructed speech image output from the image reconstruction unit is close to the speech image input to the image feature extraction unit.

5. The device of claim 3, wherein the image feature extraction unit receives the speech image in units of image frames, and extracts an image feature for each of the image frames to output an image feature sequence; and
the image reconstruction unit outputs the speech image reconstructed for each of the image frames with the image feature for each of the image frames as an input.

6. The device of claim 5, wherein the second machine learning model includes: a voice feature extraction unit configured to extract a voice feature with the speech audio signal as an input; and
an image feature prediction unit configured to predict the image feature output from the image feature extraction unit with the voice feature output from the voice feature extraction unit as an input.

7. The device of claim 6, wherein the voice feature extraction unit extracts a voice feature from the speech audio signal for a section corresponding to each of the image frames to output a voice feature sequence; and
the image feature prediction unit predicts the image feature sequence with the voice feature sequence as an input.

8. The device of claim 7, wherein the image feature prediction unit predicts an image feature of an n-th image frame in the speech image based on a voice feature extracted from a section of a speech audio signal corresponding to the n-th image frame.

9. The device of claim 7, wherein a loss function (L_{seq}) of the second machine learning model is expressed by Equation below:
L_{seq}=∥Z−\hat{Z}∥ [Equation]
where Z: Image feature sequence generated by the image feature extraction unit of the first machine learning model, Z={E_{img}(y₀;θ_{enc}), E_{img}(y₁;θ_{enc}), . . . E_{img}(yₙ;θ_{enc})};
E_{img}: Neural network constituting the image feature extraction unit;
θ_{enc}: Parameter of the neural network E_{img};
yₙ: n-th image frame of the speech image Y;
\hat{Z}: Image feature sequence output from the image feature prediction unit of the second machine learning model, \hat{Z}=P(E_{aud}(X;φ_{enc}); ϕₚ);
E_{aud}: Neural network constituting the voice feature extraction unit;
ϕ_{enc}: Parameter of the neural network E_{aud};
P: Neural network constituting the image feature prediction unit;
ϕₚ: Parameter of the neural network P;
X: Speech audio signal, X={x₀, x₁, x₂, . . . , xₙ};
xₙ: Speech audio signal corresponding to the n-th image frame;
∥Z−\hat{Z}∥: Function for finding the difference between Z and \hat{Z}.

10. The device of claim 9, wherein an optimized parameter (φ*_{enc}, φ*ₚ) of the second machine learning model is calculated by Equation below:
φ*_{enc}, φ*ₚ=arg min_{φenc, φp} L_{seq} [Equation]
where arg min_{ϕenc,ϕp}L_{seq}: A function for finding ϕ_{enc}, ϕₚ, which minimizes L_{seq} (the loss function of the second machine learning model).

11. A method for generating a speech image that is executed by a computing device including one or more processors and a memory storing one or more programs executed by the one or more processors, the method comprising:
extracting, in a first machine learning model, an image feature with a speech image of a person as an input to reconstruct the speech image from the extracted image feature; and
predicting, in a second machine learning model, the image feature with a speech audio signal of the person as an input.
